(19) United States
(12) Patent Application Publication
(10) Pub. No.: US 2018/0130118 A1
(43) Pub. Date: May 10, 2018

(54) System, Method and Related Software for Providing Seat Delivery Services of Goods

(71) Applicants: John M. Guran, Durham, NC (US); Matthew P. Guran, Greensboro, NC (US)

(72) Inventors: John M. Guran, Durham, NC (US); Matthew P. Guran, Greensboro, NC (US)

(21) Appl. No.: 15/808,296

(22) Filed: Nov. 9, 2017

Related U.S. Application Data
(60) Provisional application No. 62/419,690, filed on Nov. 9, 2016.

(51) Int. Cl. G06Q 30/06; G06Q 10/02; G06Q 10/08; G06Q 20/32; G06Q 20/40

(52) U.S. Cl. CPC G06Q 30/0635; G06Q 10/02; G06K 7/10762; G06Q 20/3226; G06Q 20/4014; G06Q 10/083

(57) ABSTRACT

Provided is a seat delivery service application which allows consumers to order and electronically pay for goods to be delivered directly to their seats during a sporting or entertainment event. The seat delivery service application provides a means for consumers to transmit their seating location directly to the vendors by obtaining the consumer's seating information from the consumer's ticket for the event. The seat delivery service application also provides a means for consumers to verify their age by allowing consumers to transmit their driver's license information directly to the vendors. The seat delivery service application also includes a wireless access restriction feature which only allows the application to be activated when it is determined that the consumer has entered the venue.

### I. BACKGROUND

### A. Technical Field

Provided is a system and method for patrons of sporting and entertainment venues to order food, beverages and other items from their seat and have those items delivered to their seat through a smart-phone seat delivery service application or “app”.

### B. Description of Related Art

Individuals or patrons attending sporting and entertainment events from time to time wish to frequent concession stands, souvenir shops and other retail shops within a venue hosting the event, however, it can be difficult for patrons to leave their seat depending on the size of the crowd and the position of their seat within the stands. Also, patrons may not want to leave their seat at a particular moment to walk up to a concession stand or retail shop because they would miss seeing a particular point or play in the game or a portion of the entertainment event. Many sporting event and entertainment venues resolve this issue by allowing vendors to walk through the stands carrying food, beverages and other concessions and items for purchase by the patrons of the sporting or entertainment event.

The use of vendors to bring concessions and other items of purchase provides several inherent disadvantages. First, vendors can only carry so many items for sale and are therefore, limited as to both the quantity and type of items that they can carry. This provides the consumer with limited options. Second, the job of a vendor can be somewhat inefficient as they spend a lot of time walking through the stands before they make a sale. Third, individuals located within a specific area or section of the stands might not be able to find a vendor available if the vendor designated to his section is located within a specific aisle or row and is particularly busy. These individuals would have to wait a long time before a vendor would be able to make it to their area so that they could place an order.

Other disadvantages are the result of the nature of the transaction between the vendor and the customer or patron attending the event. When a sale is made with a vendor who is walking through the stands, the vendor and customer must make the financial transaction both at the moment and at the location of the sale in order to complete the sale and transfer of goods. This involves either the passage of money or credit card to the vendor before the vendor can deliver the goods to the customer. This can result in several problems and inconveniences. First, if the customer is sitting within the middle of a row filled with other patrons, the customer may have to pass the cash or credit card to several other people sitting in the stands before it can reach the vendor. If dealing with cash, the vendor would have to then pass any change owed back to the customer to the other patrons sitting next to the customer before it reaches the customer. In some cases, the money or credit card is dropped creating an inconvenience for the customer, vendor and other patrons. The entire process for completing this financial transaction is time consuming, cumbersome, inefficient and inconvenient. The patron will receive his or her goods, however, the customer and the other patrons sitting next to the customer will also miss viewing a portion of the event.

Several service applications have been developed to attempt to provide delivery services to attendees of entertainment and sporting events. Examples of such services include SeatServe, FanGo, GrubRunner, Yorder and Snagmobile. Each of these seat delivery service applications, however, are also inherently inefficient and cumbersome to use in that they require that the user enter his or her location within the stadium (including section, row and seat number) in order to have his or her order delivered to his or her seat. Accordingly, these seat delivery service applications do not have the ability to automatically identify the location of the customer within the stadium, arena or venue. Other features not included within these service applications include certain authentication and verification features to ensure that only certain types of individuals are allowed to place orders.

What is therefore needed is a seat delivery service application on a mobile device which will allow a customer attending a sporting or entertainment event to place an order for goods without having to leave his or her seat, which will allow the customer to pay for those goods ahead of time before the vendor delivers the goods to the customer and which does not require the customer to enter his seat location. What is also needed is a seat delivery service application having the proper security features to allow only certain types of individuals to make purchases through the seat delivery service application. These and other features of the presently disclosed seat delivery service application are discussed in detail below.

### II. SUMMARY

Provided is a seat delivery service application run on a computer-readable-medium of a mobile device having software instructions for the seat delivery service application stored therein. The seat delivery service application is part of a system which operates by a seat delivery service application run on a consumer's mobile device communicating with a seat delivery service application run on a vendor's mobile device. The seat delivery service application on the consumer's mobile device is designed to obtain the consumer's seating information from the consumer's ticket and communicate that information to the vendor's seat delivery service application allowing the vendor to locate the consumer within the venue. The seat delivery application further allows the consumer to place orders for goods from a menu and to pay for the goods ahead of time through an electronic financial transaction. Once the vendor receives the order for the goods and confirmation that payment has been made, the vendor can deliver the goods directly to the consumer.

In further embodiments, the seat delivery service application also includes an age verification system to allow for the purchase of restricted goods such as alcoholic beverages. The age verification system operates by allowing the consumer to transmit information related to the consumer's driver's license directly to the vendor through the seat delivery service application.

In further embodiments, the seat delivery service application includes a wireless access restriction feature. The wireless access restriction feature allows the seat delivery service application to be activated for purchases only when the user has entered and is inside of the venue hosting the event. This feature may be operated by entering a code within the seat delivery service application or by the seat delivery service application wirelessly communicating with a server operated by the venue hosting the event which would detect that the mobile device containing the seat delivery service application is located inside the venue. In a further embodiment, this feature may be operated by a gatekeeper at the event scanning, validating and marking the ticket with a validation mark (e.g., a validation code) when the patron enters the venue. The gatekeeper or patron may then transmit a signal indicating that the ticket has been validated from a mobile device to a venue's server to indicate that the patron has entered the venue. The venue's server would then send a return signal to the patron's mobile device activating the seat delivery service application for use.

### III. BRIEF DESCRIPTION OF THE DRAWINGS

FIG. 1 is a flow chart showing exemplary steps, which may be followed to place an order through the seat delivery service application.

### IV. DETAILED DESCRIPTION

Provided is a system and method for ordering food, beverages and other items at a sporting or entertainment venue. The system and method is designed to operate through a computer software program or seat delivery service application, referred to as an “seat delivery service application” which is run on a patron's or customer's portable computing device such as a smartphone, tablet or other mobile device. The system and method is also designed to operate on a computer software program or seat delivery service application, referred to as a “seat delivery service application” which is run on a vendor's portable computing device such as a smartphone, tablet or other mobile device and to interface with a vendor's point-of-sale (POS) software used to track and account for transactions made at a retail counter. The computer software program or seat delivery service application disclosed herein may also be referred to as a seat delivery service application, a selective seat service smart-phone seat delivery service application, a personal waiter seat delivery service application, a traveling butler, a seat delivery service application, and a personal assistant seat delivery service application.

In certain embodiments, the seat delivery service application is run on both a customer's mobile device and a vendor's mobile device. The seat delivery service application may also be universal meaning that it can be used across different venues and events as well as on different days throughout the year. For example, a customer who attends a particular sporting event such as a baseball game in April and who attends a concert located in a different city in June may use the seat delivery service application for both events.

In certain embodiments, the seat delivery service application is designed to provide a template for vendors to list any items which they plan to sell at the sporting or entertainment event on a particular day. This allows customers who log onto the seat delivery service application through their mobile device to see what items a particular vendor or group of vendors is offering for sale for a specific event. Registration of the items for sale on the seat delivery service application may be accomplished separately by each vendor on an individual basis, by a group of vendors, by the venue offering the items for sale or by the vendor's distributor offering the items for sale. The seat delivery service application may also allow vendors or associated parties to change the items listed for sale on the seat delivery service application depending upon the particular event, venue or day.

Depending upon their employment agreement with the venue hosting the event, vendors may be employees of the venue or host of the venue or may be independent contractors. Regardless of their specific employment arrangement, vendors would be required to register with the seat delivery service application and to submit some form of proof to the seat delivery service application which establishes that they are authorized to provide services at a particular venue on a particular day or for a particular period of time (e.g., for designated days, weeks or months). The seat delivery service application will then authenticate the vendor's account through information such as a code entered by the vendor which is provided to the vendor by the vendor's employer or the venue or host which allows the vendor to conduct business on the premises. Once the vendor's account is authenticated, the vendor is allowed to register the account and obtain access to the seat delivery service application through a license. Once the vendor obtains, agrees and signs the license for the software, the vendor may complete the download of the software and begin using the seat delivery service application on his or her mobile device.

In further embodiments, each vendor within a group of vendors may be registered for and associated with specific items for sale on the seat delivery service application. Each listing of a group of items for sale on the seat delivery service application for a particular vendor may be referred to as a vendor's on-sale listing account. In such cases, the seat delivery service application also provides a means for vendors to switch to sell items of a different on-sale listing account depending on particular customer needs at the venue hosting the event. The seat delivery service application may also provide a means for vendors to swap on-sale listing accounts to sell different items on different days. The seat delivery service application of on-sale listing accounts may depend on availability of other vendors on certain days, the customers' needs at the venue on a particular day, the efficiency of particular vendors within certain sections and any other reasons. Switching and seat delivery service application of on-sale listing accounts may be at the discretion of the individual vendors or at the request of the vendors' employer. In addition, in certain embodiments, the seat delivery service application may provide vendors with an option to advertise sales or discounted merchandise within the on-sale listing on the application before game time and to advertise sales or discounts for other venues close to the event.

The customer or patron attending the event who wishes to use the seat delivery service application will download the seat delivery service application on his or her mobile device. If the customer or patron desires to use the seat delivery service application for a particular sporting or entertainment event, the customer or patron will first have to activate the seat delivery service application for the event that he or she is attending. In order to activate the seat delivery service application, the customer or patron will have to first establish that he or she has paid for and will be attending the event. In certain embodiments, this can be accomplished by the customer or patron, scanning a barcode, QR code or any other code on the ticket with his or her mobile device and transferring the information scanned to the seat delivery service application which will verify and authenticate the customer's ticket for the event. Once the customer's ticket is authenticated, the customer will have access to view items offered for sale through the seat delivery service application by various vendors. Also, authentication of the customer's ticket for the event will provide vendors with access to the customer's specific seat location for the event including the section, row and seat number. This provides the vendor with the specific information to know exactly where the customer is seated so that the ordered goods are delivered both efficiently and accurately.

In order for the customer to use the seat delivery service application, he or she will first have to enter and store his or her credit card information onto the seat delivery service application. This will allow the customer to conduct electronic transactions through the seat delivery service application when ordering items offered for sale by vendors through the seat delivery service application. In certain embodiments, the customer may enter his or her debit card information into the seat delivery service application as an alternative to providing a credit card number. Once the customer's financial information is entered into the seat delivery service application, the customer is enabled to make purchases through the seat delivery service application from the vendor. When the customer places an order on the seat delivery service application, the seat delivery service application will transfer the order information to the seat delivery service application on the vendor's mobile device. The vendor will then receive and be able to view the order information through the seat delivery service application on his or her mobile device from the seat delivery service application. The seat delivery service application will then provide the vendor with confirmation that the customer's payment has been approved by his or her credit card company or bank. For security purposes, in certain embodiments, the customer's credit card or debit card number need not be shown to the vendor. Rather, the vendor will simply be notified through the seat delivery service application that the customer's electronic payment has been accepted. Once the vendor has received confirmation that the customer's electronic payment has been accepted, he or she may continue with completing the customer's order by delivering the requested goods directly to the customer. In a further embodiment, the vendor seat delivery service application may be run on a mobile device having a card reader which allows the mobile device to read data stored within a magnetic strip or a chip of a card such as a credit card, a debit card or a type of identification card. The card reader may be an integral component of the mobile device or a separate, secondary component that is connected to the mobile device. This embodiment allows patrons to present a credit or debit card to the vendor to complete a transaction instead of entering their financial information directly in the seat delivery service application to purchase goods. It also allows the patron to present an identification card such as a driver's license to the vendor, who would use the card reader to verify the identity of the patron and/or that the patron meets certain age qualifications to purchase restricted goods such as alcohol.

In certain embodiments, all gratuity costs are built into the prices advertised for the goods which are listed for sale on the seat delivery service application. The seat delivery service application may be designed to publicize this information to the customer so that the customer knows and understands that a gratuity for the vendor is not required when the goods are delivered. This allows the vendor to quickly and efficiently deliver the goods to the customer in the stands without the customer having to transfer any cash to the vendor. In addition, in certain cases, there are no fixed minimum transaction fees charged per order to the vendor/licensee for use of the seat delivery service application. Rather, license fees may be structured so that they are computed as a percentage of the total purchase amount. Thus, the customer does not feel that he is paying a premium for the delivery service. In certain cases, the vendor may establish minimum purchase amounts eligible for delivery to the seat to cover delivery costs to the customer. If the customer does not meet the minimum purchase amount designated by the vendor, the seat delivery service application will inform the customer that his or her order will have to be picked up at an express pick-up window.

In certain cases, the resources available to meet customer's demand at a particular time during the event may be limited. For example, at any particular time, the number of vendors available to deliver goods to the customers within the stands may be limited or the individuals preparing food may be backed up with orders. In such cases, depending upon the availability of food service resources available at a particular venue and a vendor's ability to scale up to meet demand, a vendor may choose to select which seats or individuals are eligible to receive deliveries at the customer's seat and which seats are eligible for the customer to go to an “express pick-up window” or line to receive the purchased goods. This may be accomplished by the vendor sending a push notification through the vendor seat delivery service application to the patron seat delivery service application notifying the patron that there is, may be or will be a delay in fulfilling the order. The push notification may be used to require patrons to receive delivery of ordered goods from an “express pick-up” window or to provide patrons with the option to receive delivery of ordered goods from an “express pick-up window”. Push notifications requiring a patron to receive delivery of goods at an “express pick-up window” may also be used to provide patrons with coupons and discounts for future purchases if the patron experiences a delay in the delivery of goods that either requires them to go to the “express pick-up window” or provides them with the option of going to the “express pick-up window” to receive their goods. Such push notifications may also include discounts on other high priced merchandise offered by the venue. In situations where the customer must go to a pick-up window or line to receive the purchased goods, the goods will be provided to the customer according to their position within the order queue. In such situations, the customer will receive an order confirmation on the seat delivery service application which provides an estimated time that the order will be ready for pick-up. In other cases where the goods are to be delivered to the customer's seat, the customer may also receive an order confirmation on the seat delivery service application which provides an estimated time for delivery of the ordered goods based on their position within the order queue or offers a choice to pick up the order at an express window if faster and more convenient.

As mentioned above, the present seat delivery service application also provides a means for a vendor to immediately identify the location of the consumer sitting in the stands without having the consumer enter his or her seating information into the seat delivery service application. For example, in certain embodiments, attendees of an event which have been issued a seat specific ticket may use the seat delivery service application to scan the barcode, QR code or other code on the ticket. This is accomplished by providing the seat delivery service application with access to a camera incorporated into the mobile device. By allowing a customer who attends an event to scan the code on his ticket, no additional input is required to identify the customer's location, eliminating the chance for input errors which may lead to delay or unfulfilled orders. In other embodiments, the user of the seat delivery service application will have an electronic ticket issued through another application or stored on another application on the mobile device. In such embodiments, the seat delivery service application of the present disclosure will obtain information from the electronic ticket from the application issuing or storing the electronic ticket. Once the information from the ticket is entered into the seat delivery service application, the seat delivery service application can identify the specific location within the venue that the user is seated again, eliminating the chance for input errors which may lead to delay or unfulfilled orders.

According to a further embodiment, a venue may decide to classify or distinguish between different seating sections or types of tickets. Such seating classifications may be used by the venue to distinguish between the types of service that is provided to certain patrons. For example, a venue may decide that only certain services or goods will be provided to patrons whose ticket purchase price meets or exceeds a certain amount. According to this aspect of the present teaching, the patron seat delivery service application may only be available to patrons whose ticket purchase price meets or exceeds a certain amount. In further embodiments, the patron seat delivery service application may offer premium services such as specialized goods for sale to patrons whose ticket purchase price meets or exceeds a certain amount.

The seat delivery service application may also have the ability to identify the date listed on the ticket and to verify this date with the current date. In certain embodiments, obtaining and verifying the date on the ticket with the actual or current date is required to activate the seat delivery service application for use at a particular sporting or entertainment event. Thus, the seat delivery service application may be designed so that the seat delivery service application can only be used for purchases after the user first enters his or her ticket information within the seat delivery service application and after the seat delivery service application has verified the authenticity of the ticket and the information contained therein (for example, the date).

The seat delivery service application may also provide the user with a means to register himself or herself on the seat delivery service application and to enter his or her credit or debit card information on the seat delivery service application. In certain embodiments, registration of the user on the seat delivery service application may require the user to enter his or her driver license number and/or a biometric identifier such as a thumbprint or eye scan. This information can be used as a safeguard to verify that the credit or debit card information entered on the seat delivery service application has been entered by the actual owner of the mobile device and that the credit or debit card entered information entered into the seat delivery service application belongs to the person entering the information the seat delivery service application. For example, the biometric identifier entered for the seat delivery service application may be used to compare the biometric identifier stored on the mobile device. If a match is detected, the seat delivery service application will allow the user to enter his or her credit card information. Also, an individual's driver license information can be used to match that of the holder of the credit or debit card whose information has been entered in a verification step to provide an extra safeguard against fraud. This registration and financial information may be entered into the seat delivery service application before or after the seat delivery service application is activated for use within a particular venue. In other words, the user of the seat delivery service application does not have to be within the venue for an event in order to register and enter his or her financial information into the seat delivery service application.

Once the seat delivery service application has been set up and activated for use, the consumer may place an order and authorize payment from a previously registered and validated method of payment. In certain embodiments, the seat delivery service application may be designed so that the user may only access the designated order page for an event from the seat delivery service application interface after the credit or debit card information has been entered within the seat delivery service application and verified by the seat delivery service application. In certain embodiments, the user of the seat delivery service application may limit the amount that may be charged on his or her credit or debit card through the seat delivery service application by entering a pre-set spending limit through a control within the seat delivery service application that is secured. The pre-set spending limit is secured through the use of a password or entry of a biometric identifier or any other suitable means within the art.

Upon receipt of an order from an attendee using the seat delivery service application, the licensed owner/operator providing services at a venue will be able to charge the amount of the order against the attendee's credit or debit card information stored on the seat delivery service application. This eliminates the inconvenience of conducting a physical transfer of currency upon delivery of the goods to the consumer at his or her seat also increasing efficiencies. In certain embodiments, the seat delivery service application may be connected or synched with other online purchasing software which contains the customer's credit or debit card information. For example, the venue may have a separate software application for the purchase of tickets which stores the user's credit or debit card information. In such cases, the seat delivery service application may be connected or synched with the venue's software application allowing for purchases to be made by transferring funds through the venue's software application. Accordingly, in such embodiments, the seat delivery service application may charge the amount of the order against the current seat location previously identified by the attendee in the venue's software application. The consumer would then be billed through a secondary software application such as a software application run by the venue or organization selling the tickets for the event. Thus, in certain embodiments, the present seat delivery service application may employ other online purchasing software.

One advantage of the present seat delivery service application is that it does not require the installation and use of any proprietary hardware interfaces on existing devices. Furthermore, no proprietary hardware is required for the authorized vendor or licensee to use in processing orders. Therefore, the manufacture and use of new devices is not required. Orders can be transmitted and transactions can be processed and fulfilled using existing Point of Sale (POS) software which is run on existing mobile devices and sales terminals owned by the consumer and the vendor.

In addition to providing a pre-authorized method of payment, the seat delivery service application may also include an age verification system which allows customers to provide a verified age qualification through the seat delivery service application to vendor. This feature may be used by vendors to allow for the purchase of alcoholic beverages and other age restricted goods directly through use of the seat delivery service application. In certain embodiments, the user may scan an image of his or her driver's license onto the seat delivery service application using a camera on the mobile device. The image of the user's driver's license will be stored on the seat delivery service application and transmitted directly to the vendor when the user makes a purchase of a restricted good such as an alcoholic beverage. Vendors will then receive a notification that the consumer has purchased a restricted good such as an alcoholic beverage and will also receive a verified age qualification (e.g., an image of the purchaser's driver's license) on their mobile device through the seat delivery service application. When the vendor delivers the restricted goods (e.g., alcoholic beverages) to the consumer, he can compare the verified age qualification stored on his or her mobile device (e.g., the image of the consumer's driver's license) with the consumer who purchased the age restricted goods or alcoholic beverage. Thus, the seat delivery service application also provides a means for the vendor to verify the identity and age of the user of the seat delivery service application to protect against fraud and ensure that minors cannot purchase prohibited items such as alcoholic beverages while also eliminating the need for the consumer to present his driver's license to the vendor at the point of sale making for a more efficient transfer of goods to the consumer. If a minor is identified, the server can click a button on the application to alert authorities.

In certain embodiments, the seat delivery service application will include a wireless access restriction feature. This feature functions as a security feature allowing the seat delivery service application to be activated for purchases only when the user has entered and is inside of the venue hosting the event. The wireless access restriction feature may operate in several ways. In one embodiment, the user of the seat delivery service application may be required to enter a code provided on the ticket into the seat delivery service application to verify that he or she is attending the event. In another embodiment, the code may only be provided to the user by the venue after the user has entered the venue. This code may be sent electronically to the user's mobile device or physically provided to the user as the user enters the venue. Once the code is entered into the seat delivery service application, the user's mobile device would send a signal to the venue's server indicating that the user has entered the venue. The server would then send a return signal to the user's mobile device authorizing the activation of the seat delivery service application. In a further embodiment, the seat delivery service application may communicate wirelessly with the venue's server without the use of a code. In this case, the user may enter a prompt on the seat delivery service application to send a signal from his or her mobile device to the venue's server. The server would receive the signal transmitted by the user's mobile device and send a return signal to the user's mobile device to track and verify the location of the user. Once the server has determined that the user is within the venue, the server will send a signal to the seat delivery service application to activate it for purchases by the user. In a further embodiment, this feature may be operated by a gatekeeper at the event scanning, validating and marking the ticket with a validation mark (e.g., a validation code) when the patron enters the venue. The gatekeeper or patron may then transmit a signal indicating that the ticket has been validated from a mobile device to a venue's server to indicate that the patron has entered the venue. The venue's server or gatekeeper's mobile device would then send a return signal to the patron's mobile device activating the seat delivery service application for use.

The process and functions described herein may be implemented in hardware, software, firmware, or any combination thereof within a mobile device. If implemented in software, the functions may be stored on or transmitted over as one or more instructions or code on a computer-readable medium. The steps of the method disclosed herein may be embodied in a processor-executable software seat delivery service application or module, which may reside on a tangible, non-transitory computer-readable storage medium of a mobile device. Tangible, non-transitory computer-readable storage media may be any available media that may be accessed by a computer or mobile device. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer as well as combinations of the above. Additionally, the operations of the method disclosed herein may reside as one or any combination or set of codes and/or instructions on a tangible, non-transitory machine readable medium and/or computer-readable medium, which may be incorporated into a computer program product.

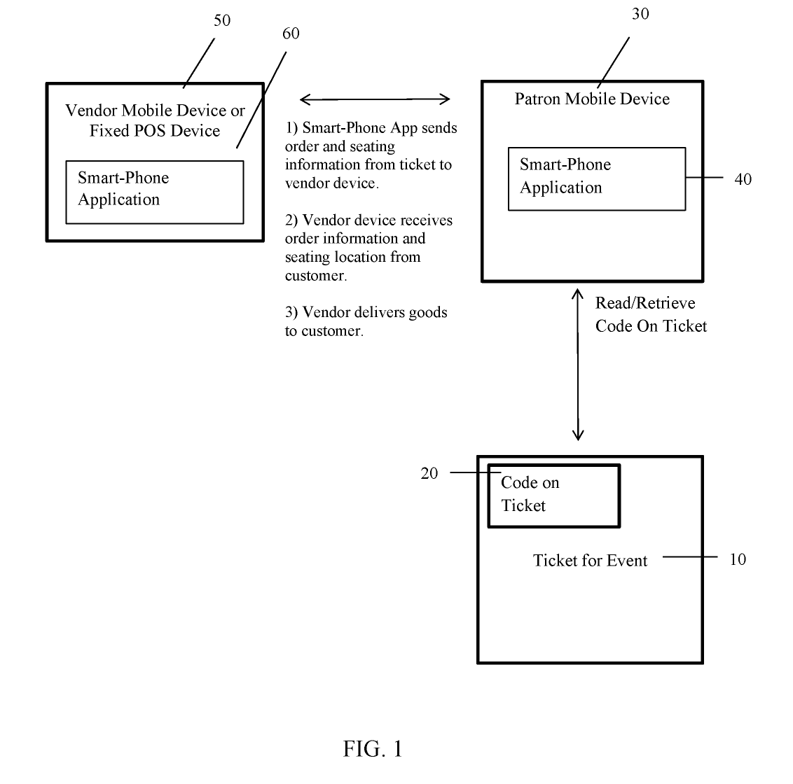

FIG. 1 is a flow chart showing the basic steps which may be followed for authenticating a ticket for an event, activating a patron's smart-phone application or patron seat delivery service application and for a patron placing an order through the patron seat delivery service application to the vendor smart-phone application or vendor seat delivery service application to have the ordered goods personally delivered to the patron at his or her seat.

The disclosed system and method for ordering goods is described in further detail below.

Provided is a system for patrons to order and purchase items from their seating location at a venue and to have such purchased items delivered to them without having to leave their seat and without having to exchange currency. The system includes a patron seat delivery service application run on a computer-readable-medium having software instructions for the seat delivery service application stored therein; a vendor seat delivery service application run on a computer-readable-medium having software instructions for the seat delivery service application stored therein; optionally, a host application which optionally i) provides an instruction to the patron seat delivery service application to activate operation of the patron seat delivery service application by the patron upon authenticating a patron's ticket to the event and upon authenticating a time period during which the event is to be held; and optionally ii) provides an instruction to the vendor seat delivery service application to activate operation of the vendor seat delivery service application by the vendor upon authenticating a vendor's employment schedule through a vendor's employment account and upon authenticating a time period during which the event is to be held. The patron seat delivery service application upon authenticating the patron's ticket, retrieves an identifier indicating a location of a patron's seat and stores data related to the patron's seating location within a memory on the computer readable medium. The patron seat delivery service application is coupled to the vendor seat delivery service application and is programmed to: i) allow the patron to access a menu or list of goods for sale on the patron seat delivery service application which is synched with a list of goods for sale on a menu on the vendor seat delivery service application; ii) allow the patron to place an order for one or more items by selecting one or more items from the menu and completing a financial transaction on the patron seat delivery service application; and iii) identify a plurality of vendors within the venue utilizing the vendor seat delivery service application. The vendor seat delivery service application computes a vendor's availability based on an estimated time for the vendor to retrieve goods purchased by the patron and to deliver the goods to the patron to complete the transaction based on a queue of previous purchases transmitted to the vendor seat delivery service application from a plurality of patron seat delivery service applications, the location of the vendor within the venue and the estimated time to prepare and/or obtain the goods for delivery. The computation is based on an algorithm that continuously re-calculates the estimated time for delivery of goods in real-time based on a change of events. The vendor seat delivery service application transmits the computation to the patron seat delivery service application. The patron seat delivery service application selects a vendor that is most available to send a purchase order to and transmits the order to the vendor seat delivery service application. The vendor seat delivery service application is synched to the patron seat delivery service application and is programmed to: i) receive an order placed by the patron on the patron seat delivery service application and notify the vendor that the order that has been placed; ii) alert the vendor of the specific location of the patron's seat within the venue; iii) compute the estimated time for the vendor to retrieve goods purchased by the patron and to deliver the goods to the patron to complete the transaction; and iv) transmit to the patron seat delivery service application the estimated time for the vendor to complete the transaction.

According to certain aspects of the present teaching, the computer-readable-medium upon which the patron seat delivery service application is run is a mobile device and the computer-readable-medium upon which the vendor seat delivery service application is run is a mobile device. According to further aspects of the present teaching, the mobile device may be a mobile phone, a tablet, a personal digital assistant, a laptop, or a mobile electronic device.

According to certain aspects of the present teaching, the vendor seat delivery service application computes the estimated time for the vendor to retrieve goods purchased by the patron and to deliver the goods to the patron to complete the transaction based on a queue of previous purchases transmitted to the vendor seat delivery service application from a plurality of patron seat delivery service applications, the location of the vendor within the venue and the estimated time to prepare and/or obtain the goods for delivery.

According to certain aspects of the present teaching, the estimated time to obtain and deliver the goods to the patron is based on an algorithm. According to further aspects of the present teaching, the algorithm continuously re-calculates the estimated delivery time of goods in real-time to the customer based on a set of conditions comprising availability of inventory and an actual time period it takes to prepare the goods, an actual time period it takes for the vendor to complete prior orders or transactions, a vendor's availability and a vendor's location with respect to the patron. The vendor seat delivery service application transmits an updated estimated time to deliver goods to the patron seat delivery service application upon completing a re-calculation of the estimated delivery time.

According to certain aspects of the present teaching, the patron seat delivery service application and the vendor seat delivery service application may be activated for use at a plurality of different events which may be held at the same or different venues.

According to certain aspects of the present teaching, the patron seat delivery service application is activated upon completion of the following events: i) the patron establishing within the patron seat delivery service application that he or she has purchased a ticket for a specific event; ii) the patron seat delivery service application authenticating the patron's ticket, and; iii) the patron seat delivery service application authenticating a specific time period wherein activation of the patron seat delivery service application is permitted for use for a specific event.

According to certain aspects of the present teaching, authentication is accomplished by the patron scanning a code displayed on the ticket on the patron's mobile device if the patron has a physical ticket on hand. According to further aspects of the present teaching, authentication is accomplished by the patron seat delivery service application retrieving a signal from a ticket purchasing application on the patron's mobile device which verifies that an electronic ticket has been purchased through the ticket purchasing application to enter the venue hosting the event.

According to certain aspects of the present teaching, authentication is not permitted until after the patron has entered the venue hosting the event. Furthermore, according to certain embodiments, authentication does not occur until a gatekeeper at the venue hosting the event uses a computing device to scan an electronic ticket presented by the patron and purchased through a ticket purchasing application, the gatekeeper's computing device sends a signal to the patron's mobile device indicating that the electronic ticket has been read, accepted and that the patron has entered the venue. Once the patron's ticket purchasing application receives a signal from the gatekeeper's computing device indicating that the electronic ticket has been authenticated and validated and the patron has entered the venue, the patron's ticket purchasing application transmits a signal to the patron seat delivery service application indicating that the patron is inside the venue thereby activating the patron seat delivery service application for use by the patron to make purchases.

According to further embodiments, authentication does not occur until the gatekeeper at the venue hosting the event uses a computing device to scan a physical ticket held by the patron, the patron seat delivery service application verifies the date and start and end time for the event by comparing date and time registered on the patron's mobile device and the patron seat delivery seat application verifies that the patron is within the venue hosting the event by verifying the patron's location through a global positioning system application. Once these checks have accord, the patron seat delivery service application may be activated for purchases. According to further aspects of the present disclosure, the patron seat delivery service application may be integrated within a ticket purchasing application.

As mentioned above, according to certain aspects of the present teaching, authentication is not permitted until after the patron has entered the venue hosting the event. According to further aspects of the present teaching, the patron seat delivery service application includes a wireless access restriction feature. The wireless access restriction feature functions by the patron seat delivery service application sending a wireless electronic signal to a venue's server upon the patron entering into the venue. Upon receipt of the signal from the patron seat delivery service application, the venue's server sends a return signal to the patron seat delivery service application including an access code to activate the patron seat delivery service application for use. The access code may be manually entered by the user to activate the patron seat delivery service application or automatically trigger activation of the patron seat delivery service application.

According to certain aspects of the present teaching, the patron seat delivery service application requires the patron to enter his or her financial information with a financial institution to conduct electronic transactions.

According to certain aspects of the present teaching, the patron seat delivery service application electronically transmits the patron's financial information to the financial institution for authorization for a purchase. The patron seat delivery service application approves the purchase of goods upon electronically receiving authorization from the patron's financial institution. The patron seat delivery service application electronically transmits details with respect to a purchased order to the vendor seat delivery service application upon receiving authorization of payment from the patron's financial institution. According to further aspects of the present teaching, the patron's financial information is not electronically transmitted to the vendor seat delivery service application.

According to certain aspects of the present teaching, all gratuity costs are built into the prices advertised for the goods on the patron seat delivery service application.

According to certain aspects of the present teaching, the vendor seat delivery service application provides an on-sale listing account for vendors and associated parties to list and modify goods for sale according to product availability for a specific event. The on-sale listing account may be associated with a specific vendor, may be associated for use on certain days, and may be associated for use for certain events to sell a certain set of goods. The vendor seat delivery service application may also provide a means to transfer on-sale listing accounts to different vendors allowing such different vendors to use the vendor seat delivery service application to sell different goods, to sell on different days and/or to sell at different events.

According to certain aspects of the present teaching, the vendor seat delivery service application includes at least two on-sale listing accounts for selling different categories of goods. Each vendor may have an account with the vendor seat delivery service application which is associated with at least one on-sale listing account. In some cases vendors may have more than one on-sale listing account and may switch between accounts to sell different categories of goods. In further aspects of the present teaching, vendors who have different on-sale listing accounts may transfer accounts to sell different items on different days for different events.

According to certain aspects of the present teaching, the vendor seat delivery service application provides an option which allows the vendor to select purchases which are eligible for customers to pick-up goods at an express pick-up window and to select purchases for which customers are eligible to receive delivery of goods at their seat based on customer demand, vendor availability and availability of goods at a particular point in time. The vendor's selection for pick-up or delivery on the vendor seat delivery service application may be electronically transmitted to the patron seat delivery service application and the vendor seat delivery service application may also compute and transmit an estimated time for pick-up or delivery to the patron seat delivery service application based on an amount of previously submitted orders, an estimated time for preparation of goods, a vendor's availability and a vendor's location within the venue. According to further aspects of the present teaching, the vendor may select a recommendation to the patron to obtain the ordered goods at the express pick-up window or to wait for delivery. According to further aspects of the present teaching, the vendor seat delivery service application may automatically generate and transmit a recommendation to the patron seat delivery service application regarding whether obtaining the ordered goods at the express pick-up window or waiting for delivery of the goods is the quicker based on the number of backorders, inventory availability and vendor availability. According to further aspects of the present teaching, the patron seat delivery service application may provide the patron with the option of selecting whether to receive ordered goods at the express pick-up window or to wait for delivery.

According to certain aspects of the present teaching, the patron seat delivery service application requires the patron to enter a driver's license number and/or a biometric identifier before making purchases to verify the patron's identity and that the financial information entered on the seat delivery service application has been entered by the actual patron. Verification occurs by the patron seat delivery service application comparing the driver's license and biometric information entered into the patron seat delivery service application to information stored on the patron's mobile device.

According to certain aspects of the present teaching, the patron seat delivery service application provides an input which allows the patron to enter a pre-set spending limit on purchases made through the patron seat delivery service application.

According to certain aspects of the present teaching, the patron seat delivery service application includes an age verification system which allows patrons to provide a verified age qualification through the patron seat delivery service application to the vendor seat delivery service application for purchasing restricted goods. The age verification system stores an image of a patron's driver's license or identification card onto the patron seat delivery service application and electronically transmits the image of the patron's driver's license or identification card to the vendor seat delivery service application upon the purchase of restricted goods. The vendor may then utilize the image received on the vendor seat delivery service application to verify the identity and age of the patron upon delivery of the restricted goods without having to ask the patron to physically present a driver's license or an identification card to the vendor.

According to certain aspects of the present teaching, the patron seat delivery service application is coupled to a venue software application. The venue software application stores the patron's financial information used to make purchases. Accordingly, the patron seat delivery service application may be used to automatically charge the patron's financial institution through the venue software application utilizing the financial information stored on the venue software application. According to further aspects of the present teachings, the patron seat delivery service application is integrated within the venue software application. According to other aspects of the present teaching, the patron delivery service application, a venue software application and a ticket purchase application are integrated with each other.

According to certain aspects of the present teaching, a vendor's location within a venue may be tracked by a global positioning system coupled to the vendor seat delivery service application on the vendor's mobile device. The patron seat delivery service application may communicate wirelessly with the vendor's mobile device and the vendor seat deliver service application to allow patrons to view the location of vendors within the venue. Patrons may then select a vendor to send an order to based on the vendor's location within the venue as observed on the vendor's location as displayed on the patron seat delivery service application.

According to further aspects of the present teaching, a patron's location within a venue may be tracked by a global positioning system which is coupled to the patron seat delivery service application on the patron's mobile device. The vendor seat delivery service application may communicate wirelessly with the patron's mobile device and the patron seat delivery service application to allow vendors to view the location of patrons who are away from their primary seats. This feature may assist vendors in finding the location of patrons who have purchased general admissions tickets and who do not have an assigned seat in the venue. After utilizing the patron's global positioning system described above to identify the location of the patron within the venue, the vendor may use image of a patron's identification card such as a driver's license uploaded on the patron's seat delivery service application and transmitted to the vendor's seat delivery service application on the vendor's mobile device to verify the identity of the patron who purchased goods on the patron seat delivery service application for personal delivery.

According to further aspects of the present teaching, the patron seat delivery service application may record the purchase habits of patrons using the application. These purchase habits may be monitored and analyzed by the licensor of the application to send targeted marketing notifications, coupons, offers, etc. to the patron seat delivery service application when the application is activated for use by the patron.

Numerous embodiments have been described herein. It will be apparent to those skilled in the art that the above systems and methods may incorporate changes and modifications without departing from the general scope of this invention. It is intended to include all such modifications and alterations in so far as they come within the scope of the seat delivery service application set forth in the appended claims or the equivalents thereof. The phrase “associated with” as used in this document, refers to structures which support the disclosed system and method and may also refer to structures not disclosed herein capable of supporting the disclosed system and method. Further, the “invention” as that term is used in this document is what is claimed in the claims of this document. The right to claim elements and/or sub-combinations that are disclosed herein as other inventions in other patent documents is hereby unconditionally reserved.

Having thus described the disclosed applications, system and method, it is now claimed:

What is claimed is:

1. A system for patrons to order and purchase items from their seating location at a venue and to have such purchased items delivered to them without having to leave their seat and without having to exchange currency, the system comprising:
a patron seat delivery service application run on a computer-readable-medium having software instructions for the seat delivery service application stored therein;
a vendor seat delivery service application run on a computer-readable-medium having software instructions for the seat delivery service application stored therein;
a host application which
i) provides an instruction to the patron seat delivery service application to activate operation of the patron seat delivery service application by the patron upon authenticating a patron's ticket to the event and upon authenticating a time period during which the event is to be held; and
ii) provides an instruction to the vendor seat delivery service application to activate operation of the vendor seat delivery service application by the vendor upon authenticating a vendor's employment schedule through a vendor's employment account and upon authenticating a time period during which the event is to be held;
wherein the patron seat delivery service application upon authenticating the patron's ticket, retrieves an identifier indicating a location of a patron's seat and stores data related to the patron's seating location within a memory on the computer readable medium,
wherein the patron seat delivery service application is coupled to the vendor seat delivery service application and programmed to:
(i) allow the patron to access a menu or list of goods for sale on the patron seat delivery service application which is synched with a list of goods for sale on a menu on the vendor seat delivery service application;
(ii) allow the patron to place an order for one or more items by selecting one or more items from the menu and completing a financial transaction on the patron seat delivery service application;
(iii) identify a plurality of vendors within the venue utilizing the vendor seat delivery service application, wherein the vendor seat delivery service application computes a vendor's availability based on an estimated time for the vendor to retrieve goods purchased by the patron and to deliver the goods to the patron to complete the transaction based on a queue of previous purchases transmitted to the vendor seat delivery service application from a plurality of patron seat delivery service applications, the location of the vendor within the venue and the estimated time to prepare and/or obtain the goods for delivery, wherein the computation is based on an algorithm that continuously re-calculates the estimated time for delivery of goods in real-time based on a change of events, wherein vendor seat delivery service application transmits the computation to the patron seat delivery service application and wherein the patron seat delivery service application selects a vendor that is most available to send a purchase order to;
(iv) transmits the order to the vendor seat delivery service application;
wherein the vendor seat delivery service application is synched to the patron seat delivery service application and is programmed to:
(i) receive an order placed by the patron on the patron seat delivery service application and notify the vendor that the order that has been placed;
(ii) alert the vendor of the specific location of the patron's seat within the venue;
(iii) compute the estimated time for the vendor to retrieve goods purchased by the patron and to deliver the goods to the patron to complete the transaction;
(iv) transmit to the patron seat delivery service application the estimated time for the vendor to complete the transaction.

2. The system of claim 1, wherein the computer-readable-medium upon which the patron seat delivery service application is run is a mobile device and wherein the computer-readable-medium upon which the vendor seat delivery service application is run is a mobile device.

3. The system of claim 2, wherein the vendor seat delivery service application computes the estimated time for the vendor to retrieve goods purchased by the patron and to deliver the goods to the patron to complete the transaction based on a queue of previous purchases transmitted to the vendor seat delivery service application from a plurality of patron seat delivery service applications, the location of the vendor within the venue and the estimated time to prepare and/or obtain the goods for delivery.

4. The system of claim 3, wherein the estimated time to obtain and deliver the goods to the patron is based on an algorithm, wherein the algorithm continuously re-calculates the estimated delivery time of goods in real-time to the customer based on a set of conditions comprising availability of inventory and an actual time period it takes to prepare the goods, an actual time period it takes for the vendor to complete prior orders or transactions, a vendor's availability, a vendor's location with respect to the patron and wherein the vendor seat delivery service application transmits an updated estimated time to deliver goods to the patron seat delivery service application upon completing a re-calculation of the estimated delivery time.

5. The system of claim 4, wherein the patron seat delivery service application and the vendor seat delivery service application may be activated for use at a plurality of different events which may be held at the same or different venues.

6. The system of claim 5, wherein the patron seat delivery service application is activated upon completion of the following events: i) the patron establishing within the patron seat delivery service application that he or she has purchased a ticket for a specific event; ii) the patron seat delivery service application authenticating the patron's ticket, and; iii) the patron seat delivery service application authenticating a specific time period wherein activation of the patron seat delivery service application is permitted for use for a specific event.

7. The system of claim 6, wherein authentication is accomplished by the patron scanning a code displayed on the ticket on the patron's mobile device if the patron has a physical ticket on hand and wherein authentication is accomplished by the patron seat delivery service application retrieving a signal from a ticket purchasing application on the patron's mobile device which verifies that an electronic ticket has been purchased through the ticket purchasing application to enter the venue hosting the event.

8. The system of claim 7, wherein authentication is not permitted until after the patron has entered the venue hosting the event and
i) a gatekeeper at the venue hosting the event uses a computing device to scan an electronic ticket presented by the patron and purchased through a ticket purchasing application, wherein the gatekeeper's computing device sends a signal to the patron's mobile device indicating that the electronic ticket has been read, accepted and that the patron has entered the venue, wherein the patron's ticket purchasing application receives a signal from the gatekeeper's computing device indicating that the electronic ticket has been authenticated and validated and that the patron has entered the venue and wherein the patron's ticket purchasing application transmits a signal to the patron seat delivery service application indicating that the patron is inside the venue thereby activating the patron seat delivery service application for use by the patron to make purchases; or
ii) the gatekeeper at the venue hosting the event uses a computing device to scan a physical ticket held by the patron, wherein the patron seat delivery service application verifies the date and start and end time for the event by comparing date and time registered on the patron's mobile device and wherein the patron seat delivery seat application verifies that the patron is within the venue hosting the event by verifying the patron's location through a global positioning system application before activating the patron seat delivery service application for purchases.

9. The system of claim 7, wherein authentication is not permitted until after the patron has entered the venue hosting the event and wherein the patron seat delivery service application comprises a wireless restriction feature, wherein the wireless restriction feature functions by the patron seat delivery service application sending a wireless electronic signal to a venue's server upon the patron entering into the venue, wherein upon receipt of the signal from the patron seat delivery service application, the venue's server sends a return signal to the patron seat delivery service application including an access code to activate the patron seat delivery service application for use, wherein the access code may be manually entered by the user to activate the patron seat delivery service application or automatically trigger activation of the patron seat delivery service application.

10. The system of claim 8, wherein the patron seat delivery service application requires the patron to enter his or her financial information with a financial institution to conduct electronic transactions.

11. The system of claim 10, wherein the patron seat delivery service application electronically transmits the patron's financial information to the financial institution for authorization for a purchase, wherein the patron seat delivery service application approves the purchase of goods upon electronically receiving authorization from the patron's financial institution, wherein the patron seat delivery service application electronically transmits details with respect to a purchased order to the vendor seat delivery service application upon receiving authorization of payment from the patron's financial institution and wherein the patron's financial information is not electronically transmitted to the vendor seat delivery service application.

12. The system of claim 11, wherein all gratuity costs are built into the prices advertised for the goods on the patron seat delivery service application.

13. The system of claim 12, wherein the vendor seat delivery service application provides an on-sale listing account for vendors and associated parties to list and modify goods for sale according to product availability for a specific event, wherein the on-sale listing account is associated with a specific vendor for use on certain days for certain events to sell a certain set of goods, and wherein the vendor seat delivery service application provides a means to transfer on-sale listing accounts to different vendors allowing such different vendors to use the vendor seat delivery service application to sell different goods, to sell on different days and/or to sell at different events.

14. The system of claim 13, wherein the vendor seat delivery service application comprises at least two on-sale listing accounts for selling different categories of goods, wherein each vendor has an account with the vendor seat delivery service application which is associated with at least one on-sale listing account, wherein each vendor who has more than one on-sale listing account may switch between accounts to sell different categories of goods and wherein vendor's who have different on-sale listing accounts may transfer accounts to sell different items on different days for different events.

15. The system of claim 14, wherein the vendor seat delivery service application provides an option which allows the vendor to select purchases which are eligible for customers to pick-up goods at an express pick-up window and to select purchases for which customers are eligible to receive delivery of goods at their seat based on customer demand, vendor availability and availability of goods at a particular point in time, wherein the vendor's selection for pick-up or delivery on the vendor seat delivery service application is electronically transmitted to the patron seat delivery service application and wherein the vendor seat delivery service application computes and transmits an estimated time for pick-up or delivery to the patron seat delivery service application based on an amount of previously submitted orders, an estimated time for preparation of goods, a vendor's availability and a vendor's location within the venue.

16. The system of claim 11, wherein the patron seat delivery service application requires the patron to enter a driver's license number and/or a biometric identifier before making purchases to verify the patron's identity and that the financial information entered on the seat delivery service application has been entered by the actual patron, wherein verification occurs by the patron seat delivery service application comparing the driver's license and biometric information entered into the patron seat delivery service application to information stored on the patron's mobile device.

17. The system of claim 11, wherein the patron seat delivery service application provides an input which allows the patron to enter a pre-set spending limit on purchases made through the patron seat delivery service application.

18. The system of claim 1, wherein the patron seat delivery service application includes an age verification system which allows patrons to provide a verified age qualification through the patron seat delivery service application to the vendor seat delivery service application for purchasing restricted goods, wherein the age verification system stores an image of a patron's driver's license or identification card onto the patron seat delivery service application and electronically transmits the image of the patron's driver's license or identification card to the vendor seat delivery service application upon the purchase of restricted goods, wherein the vendor utilizes the image received on the vendor seat delivery service application to verify the identity and age of the patron upon delivery of the restricted goods without having to ask the patron to physically present a driver's license or an identification card to the vendor.

19. The system of claim 11, wherein the patron seat delivery service application is coupled to a venue software application, wherein the venue software application stores the patron's financial information used to make purchases, wherein use of the patron seat delivery service application automatically charges the patron's financial institution through the venue software application utilizing the financial information stored on the venue software application.

20. The system of claim 1, wherein a global positioning system on a vendor's mobile device tracks the location of vendors within the venue through the vendor seat delivery service application, wherein the patron seat delivery service application is coupled to the global positioning system allowing patrons to view the location of vendors within the venue and wherein the patron may select a vendor to send an order to based on the vendor's location within the venue as observed on the vendor's location as displayed on the patron seat delivery service application and wherein a global positioning system on a patron's mobile device tracks the location of patrons within the venue through the patron seat delivery service application and wherein the vendor seat delivery service application is coupled to the global positioning system allowing vendors to view the location of patrons within the venue.
